(19) United States
(12) Patent Application Publication
(10) Pub. No.: US 2024/0275425 A1
(43) Pub. Date: Aug. 15, 2024

(54) SYSTEMS AND METHODS FOR REDUCING LOCAL OSCILLATOR LEAKAGE

(71) Applicant: Samsung Electronics Co., Ltd., Suwon-si (KR)

(72) Inventors: Omar Abdulmonem Mohamed ELSAYED, San Jose, CA (US); Tienyu CHANG, Sunnyvale, CA (US); Fan ZHANG, Los Altos, CA (US); Siuchuang Ivan LU, San Jose, CA (US); Sangwon SON, Palo Alto, CA (US)

(21) Appl. No.: 18/180,832

(22) Filed: Mar. 8, 2023

Related U.S. Application Data
(60) Provisional application No. 63/445,446, filed on Feb. 14, 2023.

(51) Int. Cl. H04B 1/525

(52) U.S. Cl. CPC H04B 1/525

(57) ABSTRACT

A system and a method are disclosed for reducing local oscillator leakage. In some embodiments, a system includes a circuit, including: a mixer; and a bias control circuit, the mixer having a first local oscillator input, the bias control circuit being configured to control a bias at the first local oscillator input.

### CROSS-REFERENCE TO RELATED APPLICATION

This application claims the priority benefit under 35 U.S.C. § 119(e) of U.S. Provisional Application No. 63/445,446, filed on Feb. 14, 2023, the disclosure of which is incorporated by reference in its entirety as if fully set forth herein.

### TECHNICAL FIELD

The disclosure generally relates to radio frequency circuits. More particularly, the subject matter disclosed herein relates to improvements to suppression of local oscillator leakage in a radio frequency circuit.

### SUMMARY

In a Radio Frequency (RF) circuit (e.g., a microwave transmitter), a mixer may be used to perform frequency conversion (e.g., up-conversion) from an intermediate frequency to an RF frequency, by mixing with a local oscillator. The output signal, however, may include local oscillator leakage.

To solve this problem, a double balanced mixer may be employed.

One issue with the above approach is that imperfections in the double balanced mixer, or imbalances in baluns, used to convert single-ended signals to balanced signals or vice versa, may result in local oscillator leakage.

To overcome these issues, systems and methods are described herein for adjusting bias voltages at the local oscillator inputs of a double-balanced mixer to reduce local oscillator leakage.

The above approaches improve on previous methods because they may suppress local oscillator leakage in a mixer circuit that exhibits such leakage, due, for example, to imbalances in baluns or differences between the components of the mixer.

According to an embodiment of the present disclosure, there is provided a circuit, including: a mixer; and a bias control circuit, the mixer having a first local oscillator input, the bias control circuit being configured to control a bias at the first local oscillator input.

In some embodiments: the first local oscillator input is a first positive local oscillator input, and the mixer further has: a second positive local oscillator input; a first negative local oscillator input; and a second negative local oscillator input.

In some embodiments, the bias control circuit includes a first bias supply circuit for adjusting: a bias at the first positive local oscillator input and a bias at the second positive local oscillator input relative to: a bias at the first negative local oscillator input and a bias at the second negative local oscillator input.

In some embodiments, the first bias supply circuit includes a four-output current digital to analog converter.

In some embodiments, the bias control circuit further includes a second bias supply circuit for adjusting: a bias at the first positive local oscillator input and a bias at the first negative local oscillator input relative to: a bias at the second positive local oscillator input and a bias at the second negative local oscillator input.

In some embodiments, the second bias supply circuit includes a four-output current digital to analog converter.

In some embodiments, the circuit further includes a combining circuit for combining a bias generated by the first bias supply circuit with a bias generated by the second bias supply circuit.

In some embodiments, the combining circuit includes a resistor network.

In some embodiments, the combining circuit is further configured to combine a common mode bias with the bias generated by the first bias supply circuit and the bias generated by the second bias supply circuit.

In some embodiments, the circuit further includes a unity-gain operational amplifier to produce the common mode bias.

In some embodiments, the mixer includes four switches.

In some embodiments, each of the four switches is a field effect transistor.

In some embodiments, the mixer has four local oscillator inputs including the first local oscillator input, each of the four local oscillator inputs being a gate of a respective one of the field effect transistors.

According to an embodiment of the present disclosure, there is provided a circuit including: a bias control circuit; the bias control circuit being configured: to provide, to four respective local oscillator inputs of a mixer: a first bias signal, a second bias signal, a third bias signal, and a fourth bias signal; and to control second harmonic local oscillator leakage.

In some embodiments, the circuit further includes the mixer, wherein: the first bias signal is connected to a first positive local oscillator input of the mixer, the second bias signal is connected to a second positive local oscillator input of the mixer, the third bias signal is connected to a first negative local oscillator input of the mixer, the fourth bias signal is connected to a second negative local oscillator input of the mixer.

In some embodiments, the mixer includes four switches.

In some embodiments, each of the four switches is a field effect transistor.

In some embodiments, each of the local oscillator inputs of the mixer is a gate of a respective one of the field effect transistors.

In some embodiments, the bias control circuit includes a four-output current digital to analog converter.

According to an embodiment of the present disclosure, there is provided a circuit including: means for bias control; the means for bias control being configured: to provide, to four respective local oscillator inputs of a mixer: a first bias signal, a second bias signal, a third bias signal, and a fourth bias signal; and to control second harmonic local oscillator leakage.

### BRIEF DESCRIPTION OF THE DRAWINGS

In the following section, the aspects of the subject matter disclosed herein will be described with reference to exemplary embodiments illustrated in the figures, in which:

FIG. 1 is a diagram of a spectrum, according to an embodiment;

FIG. 2 is a schematic diagram of a circuit including a double-balanced mixer, according to an embodiment;

FIG. 3 is a schematic diagram of a bias control circuit, according to an embodiment; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Radio Frequency (RF) transmissions may be used in various communication applications such as in mobile telephones, in which such transmissions may be used as part of communications conducted, for example, via WiFi™, BlueTooth or cellular network. The signal to be transmitted may be generated from an intermediate frequency (IF) signal by mixing (in a mixer) the IF signal with a local oscillator (LO) signal, which may also be referred to as a clock signal. These operations may be performed in an RF integrated circuit (RFIC).

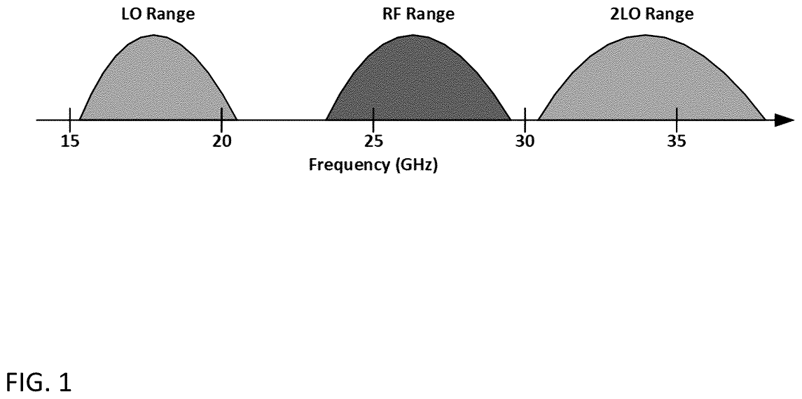

Local oscillator second harmonic (2FLO) leakage, if not mitigated, may degrade the performance of an RFIC. For example, in a fifth generation wireless (5G) Frequency Range 2 (FR2) system, the millimeter-wave (mm-wave) phased array chip may include an IF up-conversion mixer in the transmitter. The IF frequency may range between 8-10 gigahertz (GHz). In the 28 GHz band, the LO frequency may range between 16-21 GHz and the RF frequency may range between 26.5-29.5 GHz. Due to mixer non-ideality, the 2FLO emission may leak to the output and the 2FLO frequency may fall very close to the fundamental RF frequency, where it may not be readily filtered at the output. Such RF emissions may lead to spectral mask emission violations. FIG. 1 shows the spectrum for the local oscillator, the RF fundamental frequency, and the second harmonic of the local oscillator.

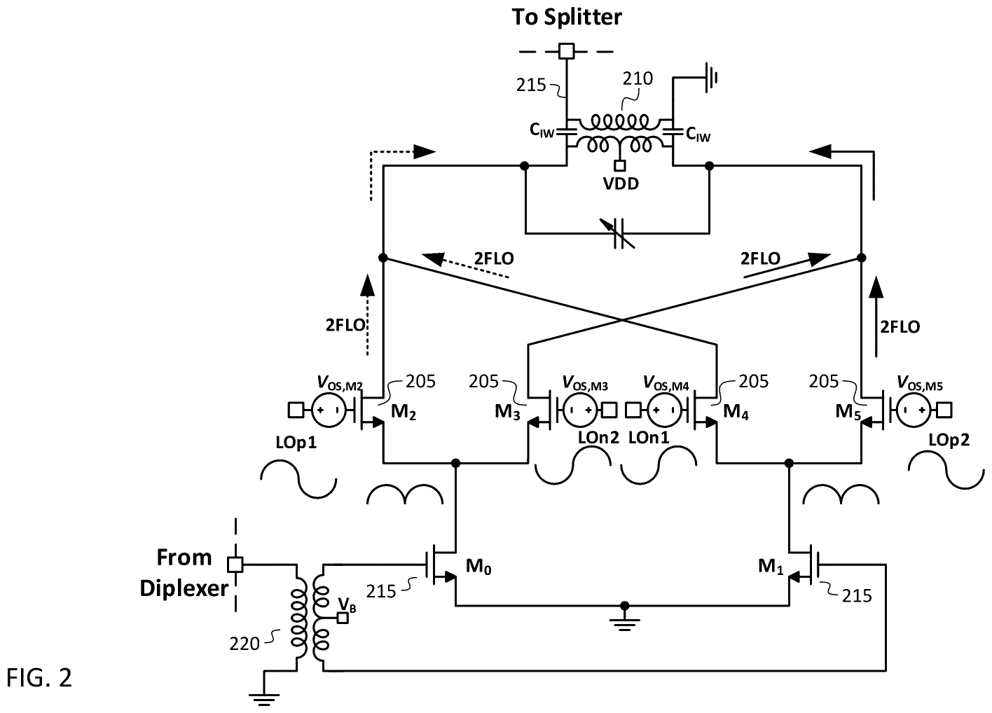

FIG. 2 shows 2FLO generation in a double balanced active mixer, which is connected to an output balun 210 and which is driven by two transistors 215 configured as IF amplifiers, which are in turn fed by an input balun 220. The mixer includes four switches (e.g., field effect transistors) 205 connected in an H-bridge which is switched by two opposite phases (which may be referred to as a positive local oscillator signal and a negative local oscillator signal) of the local oscillator. The mixer has four inputs, including a first positive local oscillator input LOp1 (connected to the positive local oscillator signal), a second positive local oscillator input LOp2 (connected to the positive local oscillator signal), a first negative local oscillator input LOn1 (connected to the negative local oscillator signal), and a second negative local oscillator input LOn2 (connected to the negative local oscillator signal). Each of the local oscillator signal connections may be capacitively coupled, so that the DC bias may be set separately (as discussed in further detail below).

A second harmonic signal may be generated at the source of each of the transistors 205. As it is an even common mode signal, the output balun 210 may partially cancel it. Imbalance in the output balun 210, however, may cause the output balun 210 to exhibit non zero conversion of common mode signal to the single ended output 215. Such an imbalance may be due, for example, to inter-winding capacitance C_{IW} between the primary and the secondary of the transformer of the output balun 210. Each side of the secondary may see a different impedance (0 ohms vs 50 ohms), and, as such, the output balun 210 may convert a non-zero component of the common mode signal to the output. In addition to this mechanism, any mismatch between the transistors 205 of the mixer (M2, M3, M4 and M5) may further degrade 2FLO emissions. The mismatch between these transistors 205 may be modeled as an offset voltage source at the gate of the transistor. A mismatch between M2 and M4 and a mismatch between M3 and M5 may degrade 2FLO emissions.

To mitigate the 2FLO leakage that may be produced by these mechanisms, the 2FLO component on one side (or on both sides) of the mixer output may be adjusted so as to reduce the overall 2FLO emission at the output. For example, the bias at LOp1 and LOn1 may be increased and the bias at LOp2 and LOn2 may be decreased, or vice versa. Leakage of the fundamental LO signal (FLO) may also be adjusted (e.g., decreased), by increasing both LOp1 and LOp2 and decreasing both LOn1 and LOn2, or vice versa.

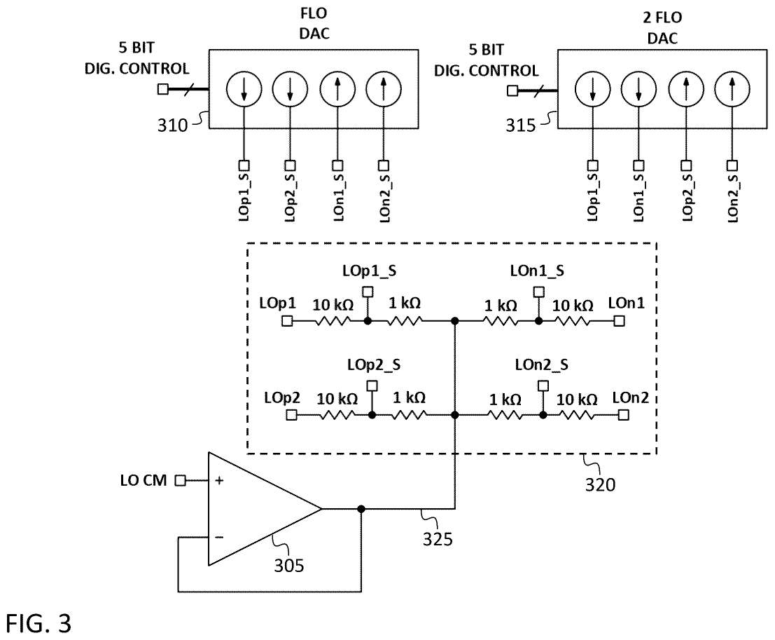

FIG. 3 shows a bias control circuit (or means for bias control), for calibrating (e.g., reducing) FLO and 2FLO leakage, in some embodiments. The bias control circuit includes an operational amplifier 305 with unity gain feedback to set the common mode bias of the gate voltage. A first current digital to analog converter (current DAC) 310 (e.g., a four-output current DAC, as illustrated), for adjusting FLO leakage, and a second current DAC 315 (e.g., a four-output current DAC, as illustrated), for adjusting 2FLO leakage, control the bias difference between the four terminals LOp1, LOn1, LOp2, and LOn2. In some embodiments, current flows in the same direction at all of the current DAC outputs (e.g., all of the outputs are current sinks); however, the direction in which the magnitude changes when the control word of the current DAC changes may differ, as shown by the arrows on the current DACs in FIG. 3. For example, when the control word of the first current DAC 310 increases, the current at each of its first two outputs (LOp1_S and LOp2 S) decreases, and the current at each of its last two outputs (LOn1_S and LOn2_S) increases. Similarly, when the control word of the second current DAC 315 increases, the current at each of its first two outputs (LOp1_S and LOn1_S) decreases, and the current at each of its last two outputs (LOp2_S and LOn2_S) increases. The outputs of the operational amplifier 305, the first current DAC 310, and the second current DAC 315 may be combined in a combining circuit which may be a resistor network 320 having four output terminals. The four output terminals of the resistor network 320 may be connected to the four mixer inputs, as indicated by the labelling in FIG. 3. The resistor network 320 illustrated in FIG. 3 includes four output resistors having resistances (e.g., 10 kilo ohms as shown) sufficiently great that their being connected to the inputs of the mixer will not significantly load the RF signal path.

When adjusting the bias to reduce 2FLO leakage, the bias voltage difference between LOp1 and LOn1, and between LOp2 and LOn2 is given by:

$$Δ {V}_{2 F L O} = 2 {R}_{D A C} \times Δ {I}_{DAC , 2 FLO} ,$$

where RDAC is the resistance (e.g., 1 kilo ohm as illustrated) between the current DAC output and the common mode node 325, and ΔI_{DAC,2FLO} is the current difference between the LOp1_S and LOn1_S currents and between the LOp2_S and LOn2_S currents. A circuit in which each of the first current DAC 310, and the second current DAC 315 is a 5-bit current DAC may be configured such that, ΔI_{DAC,2FLO}=0 for the mid-code “16” while for other codes it is given by:

$$Δ {I}_{D A C , 2 F L O} ( n ) = 2 \times ( n - 16 ) \times Δ {I}_{UNIT} ,$$

where ΔI_{UNIT} is the unit current step in the current DAC.

In some embodiments, a circuit or device (e.g., a circuit board, or a mobile phone) including an RFIC (including a mixer circuit (such as the circuit of FIG. 2)) and a bias control circuit (such as the circuit of FIG. 3) (which may be internal to the RFIC or (except for the output resistors) external to the RFIC) may be adjusted at the time of manufacture. The adjusting may include, for example, monitoring the amplitude of the FLO signal and the amplitude of the 2FLO signal, while adjusting the control words of the each of the first current DAC 310, and the second current DAC 315 until the amplitude of the FLO signal and the amplitude of the 2FLO signal are both minimized or sufficiently small to meet system requirements. The control word values may then be stored in nonvolatile memory (e.g., in the RFIC or external to the RFIC) and loaded into the first current DAC 310 and the second current DAC 315 at startup.

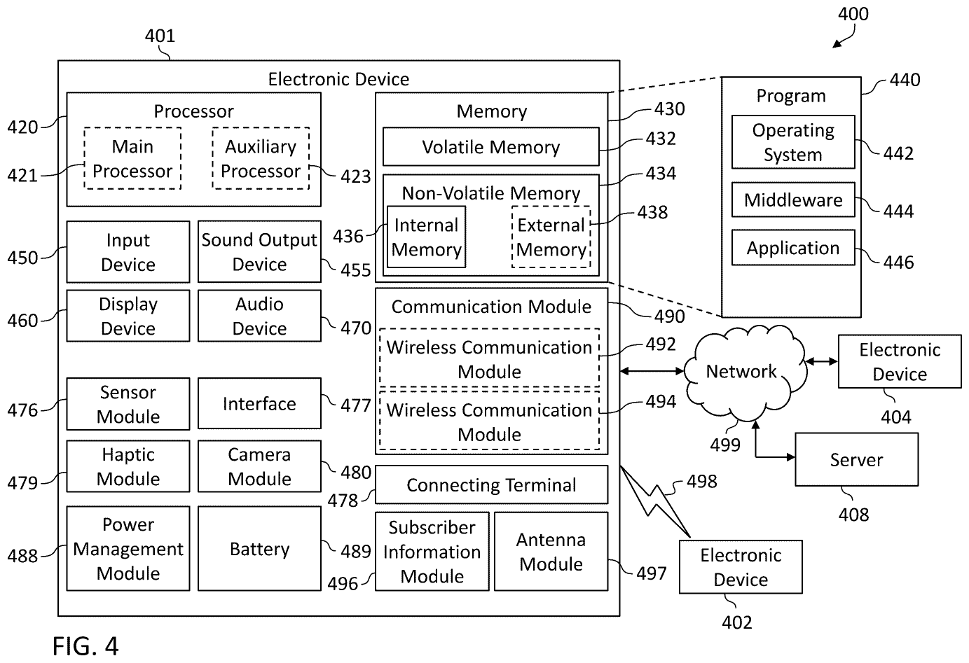

FIG. 4 is a block diagram of an electronic device in a network environment 400, according to an embodiment. Such a device, or portions of such a device, may be used to implement systems described herein.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 440, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 446 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A circuit, comprising:
a mixer; and
a bias control circuit,
the mixer having a first local oscillator input,
the bias control circuit being configured to control a bias at the first local oscillator input.

2. The circuit of claim 1, wherein:
the first local oscillator input is a first positive local oscillator input, and the mixer further has:
a second positive local oscillator input;
a first negative local oscillator input; and
a second negative local oscillator input.

3. The circuit of claim 2, wherein the bias control circuit comprises a first bias supply circuit for adjusting:
a bias at the first positive local oscillator input and
a bias at the second positive local oscillator input
relative to:
a bias at the first negative local oscillator input and a bias at the second negative local oscillator input.

4. The circuit of claim 3, wherein the first bias supply circuit comprises a four-output current digital to analog converter.

5. The circuit of claim 3, wherein the bias control circuit further comprises a second bias supply circuit for adjusting:
a bias at the first positive local oscillator input and
a bias at the first negative local oscillator input
relative to:
a bias at the second positive local oscillator input and
a bias at the second negative local oscillator input.

6. The circuit of claim 5, wherein the second bias supply circuit comprises a four-output current digital to analog converter.

7. The circuit of claim 5, further comprising a combining circuit for combining a bias generated by the first bias supply circuit with a bias generated by the second bias supply circuit.

8. The circuit of claim 7, wherein the combining circuit comprises a resistor network.

9. The circuit of claim 8, wherein the combining circuit is further configured to combine a common mode bias with the bias generated by the first bias supply circuit and the bias generated by the second bias supply circuit.

10. The circuit of claim 9, further comprising a unity-gain operational amplifier to produce the common mode bias.

11. The circuit of claim 1, wherein the mixer comprises four switches.

12. The circuit of claim 11, wherein each of the four switches is a field effect transistor.

13. The circuit of claim 12, wherein the mixer has four local oscillator inputs including the first local oscillator input, each of the four local oscillator inputs being a gate of a respective one of the field effect transistors.

14. A circuit comprising:
a bias control circuit;
the bias control circuit being configured:
to provide, to four respective local oscillator inputs of a mixer:
a first bias signal,
a second bias signal,
a third bias signal, and
a fourth bias signal; and
to control second harmonic local oscillator leakage.

15. The circuit of claim 14, further comprising the mixer, wherein:
the first bias signal is connected to a first positive local oscillator input of the mixer,
the second bias signal is connected to a second positive local oscillator input of the mixer,
the third bias signal is connected to a first negative local oscillator input of the mixer,
the fourth bias signal is connected to a second negative local oscillator input of the mixer.

16. The circuit of claim 15, wherein the mixer comprises four switches.

17. The circuit of claim 16, wherein each of the four switches is a field effect transistor.

18. The circuit of claim 17, wherein each of the local oscillator inputs of the mixer is a gate of a respective one of the field effect transistors.

19. The circuit of claim 14, wherein the bias control circuit comprises a four-output current digital to analog converter.

20. A circuit comprising:
means for bias control;
the means for bias control being configured:
to provide, to four respective local oscillator inputs of a mixer:
a first bias signal,
a second bias signal,
a third bias signal, and
a fourth bias signal; and
to control second harmonic local oscillator leakage.
